(19) United States
(12) Patent Application Publication
(10) Pub. No.: US 2007/0147262 A1
(43) Pub. Date: Jun. 28, 2007

(54) Methods, communication networks, and computer program products for storing and/or logging traffic associated with a network element based on whether the network element can be trusted

(76) Inventors: Jeffrey Aaron, Atlanta, GA (US); Edgar Shrum JR., Smyrna, GA (US)

Correspondence Address: MYERS BIGEL SIBLEY & SAJOVEC, P.A., P.O. BOX 37428, RALEIGH, NC, 27627, US

(21) Appl. No.: 11/315,572

(22) Filed: Dec. 22, 2005

(51) Int. Cl. H04J 1/16

(52) U.S. Cl. 370/250; 370/252

(57) ABSTRACT

A determination can be made whether a network element is configured in an authorized manner, e.g., whether the network element is configured with authorized firmware, software, and/or data. In this regard, a determination is made whether the network element can be trusted and to what degree the network element can be trusted. Based on this determination of whether the network element can be trusted, the traffic associated with the network element can be stored and/or logged in a desired manner.

### FIELD OF THE INVENTION

The present invention relates to communication networks and methods of operating the same, and, more particularly, to methods, systems, and computer program products for storing and/or logging of traffic on communication networks.

### BACKGROUND OF THE INVENTION

Automatic network-based storing and/or logging of traffic may be desired in certain scenarios, in particular if a network element has been modified in an undesirable fashion. For example, law enforcement and/or homeland security authorities may desire to monitor traffic in certain circumstances. Network security personnel may wish to monitor traffic when equipment or software is compromised in some way. Where loss of trust in a network element is associated with malfunctions of some kind, network operations personnel may wish to monitor the associated traffic. Monitoring in these or other situations may be accomplished by storing and/or logging the traffic, or some portion of the traffic, at a destination in the network where the stored/logged traffic may be further analyzed. Additionally, storing and/or logging of traffic may be desired for purposes other than monitoring. For example, it may be desirable to save a copy of some portion of the traffic. Traditionally, storing and/or logging of traffic have been done using static/manual techniques. These techniques, however, may be costly, inflexible, and/or may take a considerable amount of time to set up in that they are typically manually provisioned.

### SUMMARY OF THE INVENTION

According to some embodiments of the present invention, a communication network is operated by determining whether a network element can be trusted and storing and/or logging traffic associated with the network element based on whether the network element can be trusted.

In other embodiments, determining whether a network element can be trusted includes generating a first hash value based on data associated with the network element, generating a second hash value based on the data associated with the network element, and comparing the first hash value with the second hash value to determine whether the network element can be trusted.

In still other embodiments, comparing the first hash value with the second hash value to determine whether the network element can be trusted includes comparing the first hash value with the second hash value to determine a degree of trust for the network element.

In still other embodiments, storing and/or logging traffic includes selecting traffic for storing and/or logging using rules that are based on the degree of trust for the network element.

In still other embodiments, selecting traffic comprises selecting traffic for storing and/or logging based on a protocol associated with the traffic, a source and/or destination address associated with the traffic, an application associated with sending and/or receiving the traffic, and/or payloads associated with the traffic.

In still other embodiments, the rules include a prioritization of the traffic based on protocol, a prioritization of the traffic based on time to store and/or log the traffic, a prioritization of the traffic based on a source and/or destination address or range, a prioritization of the traffic based on an application associated with sending and/or receiving the traffic, and/or a prioritization of the traffic based on payloads associated with the traffic.

In still other embodiments, context information is used to adjust at least one prioritization of the traffic.

In still other embodiments, context information is used to select at least one of the prioritizations of the traffic for use in selecting the traffic for storing and/or logging.

In still other embodiments, the degree of trust for the network element is used to select at least one of the prioritizations of the traffic for use in selecting the traffic for storing and/or logging.

In still other embodiments, a determination is made whether to store or log the traffic based on the degree of trust for the network element.

In still other embodiments, a destination is selected for storing and/or logging the traffic based on the degree of trust for the network element.

In still other embodiments, generating the first hash value and generating the second hash value includes generating the first hash value and the second hash value responsive to at least one of an expiration of a timer, a packet count associated with the network element, an event associated with then network element, and a hash generation command.

In still other embodiments, storing and/or logging traffic includes storing and/or logging traffic associated with at least one of a location, a connection/session, and/or an application.

In still other embodiments, storing and/or logging of the traffic associated with the network element is stopped if it is determined that the network element can be trusted and/or upon elapse of a defined storing and/or logging time. The stored and/or logged traffic associated with the network element is retained for a duration that is based on the degree of trust for the network element.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a communication network in accordance with some embodiments of the present invention; and

FIGS. 2-4 are flowcharts that illustrate operations of storing and/or logging traffic associated with a network element based on whether the network element can be trusted in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Embodiments of the present invention are described hereafter in the context of processing a packet. It will be understood that the term “packet” means a unit of information and/or a block of data that may be transmitted electronically as a whole or via segments from one device to another. Accordingly, as used herein, the term “packet” may encompass such terms of art as “frame” and/or “message,” which may also be used to refer to a unit of transmission.

Embodiments of the present invention are also described hereafter in the context of storing and/or logging traffic associated with a network element. As used herein, storing traffic means to write at least a portion of the traffic to a medium on which a copy of at least the portion of the traffic may be retained. Logging traffic means to record information about the traffic on a medium that may allow the recorded information to be retained. For example, storing traffic may include mirroring or copying the raw, unprocessed packets or portions of packets (e.g., headers and/or payloads) that comprise a communication session to a disk, tape, flash memory, non-volatile memory, power-protected volatile memory, or similar medium, where that mirrored or copied data is stored. By contrast, logging traffic may include recording events or information describing or otherwise associated with communication session, such as identities of the elements participating in the communication session, a number of packets transmitted as part of the communication session, error rate(s) associated with the communication session, types of packets transmitted as part of the communication session, and the like.

In some embodiments of the present invention, a determination can be made whether a network element is configured in an authorized manner, e.g., whether the network element is configured with authorized firmware, software, and/or data. In this regard, a determination is made whether the network element can be trusted and to what degree the network element can be trusted. Based on this determination of whether the network element can be trusted, the traffic associated with the network element can be stored and/or logged in a desired manner. For example, what aspects of the traffic associated with the network element (e.g., headers, particular sessions, payloads, etc.) should be stored and/or logged and the particular destinations where the traffic is to be stored and/or logged (e.g., destinations associated with local authorities, FBI, Homeland Security, etc.) may be based on the level of trust for the network element.

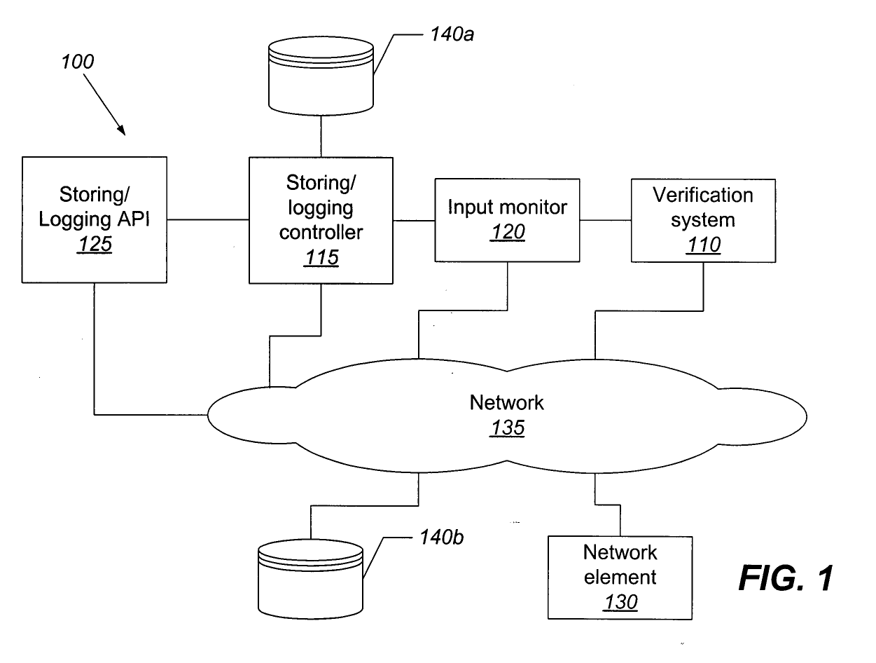

Referring now to FIG. 1, an exemplary network architecture 100 for storing and/or logging traffic associated with a network element based on whether the network element can be trusted, in accordance with some embodiments of the present invention, comprises a verification system 110, a storing/logging controller 115, an input monitor 120, a storing/logging application programming interface (API) 125, a network element 130, and a communication network 135 that are connected as shown. Storage/logging repositories 140a and 140b may be connected to the storing/logging controller 115 either through the network 135 (e.g., repository 140b) or directly without using the network 135 (e.g., repository 140a). The network 135 may represent a global network, such as the Internet, and/or other publicly accessible network. The network 135 may also, however, represent a wide area network, a local area network, an Intranet, and/or other private network, which may not accessible by the general public. Furthermore, the network 135 may represent a combination of public and private networks or a virtual private network (VPN).

The verification system 110 may be configured to determine whether the network element 130 is trustable or not, by, for example, determining a degree of trust for the network element 130. In some embodiments, trust-relevant information from additional sources could alternately or additionally be considered. Such additional trust-relevant sources may include, but are not limited to, various network management systems, policy-based control systems, monitoring systems, including intrusion detection/protection systems, security scanning systems, third party security notification systems, outsourced security consulting/management services/systems, and/or security relevant information aggregation systems. This trust information may then be provided to the storing/logging controller 115. The verification system 110 may be embodied as described in, for example, U.S. patent application Ser. No. 10/880,249 entitled “Verification of Consumer Equipment Connected to Packet Networks Based on Hashing Values” (hereinafter '249 application), and U.S. patent application Ser. No. 10/886,169 entitled “Controlling Quality of Service and Access in a Packet Network Based on Levels of Trust for Consumer Equipment” (hereinafter '169 application), the disclosures of which are hereby incorporated herein by reference in their entireties. However, other techniques of determining trust of a network element may also be used.

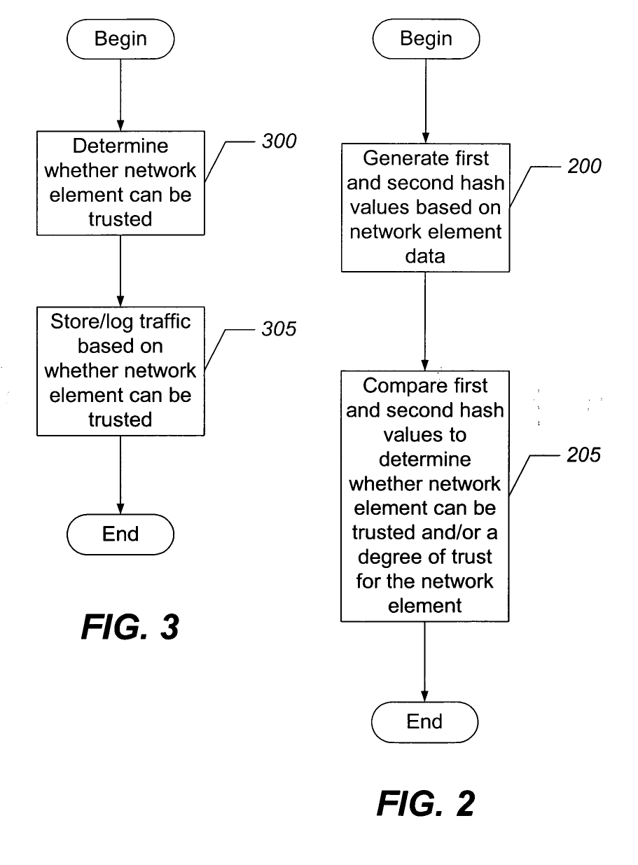

Referring to FIG. 2, as described in the '249 application and '169 application, the verification system 110 can determine a level of trust for the network element 130 by generating first and second hash values based on data that is associated with the network element 130 at block 200. This data may represent any type of software and/or firmware, for example, associated with the network element 130. If the hash values are not identical as determined by a comparison made at block 205, then an evaluation may be made to determine whether the network element 130 can be trusted and/or what degree of trust may be assigned to the network element 130.

Returning to FIG. 1, as used herein, the term “network element” includes any device that is configured to communicate traffic, such as packet traffic, using the communication network 135. Accordingly, the network element 130 may be, but is not limited to, a router, a gateway, a switching device, a cable modem, a digital subscriber line modem, a public switched telephone network modem, a wireless local area network modem, a wireless wide area network modem, a computer with a modem, a mobile terminal such as personal data assistant and/or cellular telephone with a modem. For network elements that communicate via the communication network 135 through a wireless interface, wireless protocols, such as, but not limited to, the following may be used: a cellular protocol (e.g., General Packet Radio System (GPRS), Enhanced Data Rates for Global Evolution (EDGE), Global System for Mobile Communications (GSM), code division multiple access (CDMA), wideband-CDMA, CDMA2000, and/or Universal Mobile Telecommunications System (UMTS)), a wireless local area network protocol (e.g., IEEE 802.11), a Bluetooth protocol, another RF communication protocol, and/or an optical communication protocol.

The storing/logging controller 115 may be configured to obtain trust and/or degree of trust information for network element(s) 130 from the verification system 110 via the input monitor 120. The input monitor 120 may be configured to collect the degree of trust information from the verification system 110 and process the degree of trust information so that it is in a format suitable for the storing/logging controller 115. The input monitor 120 may also collect additional information regarding the traffic associated with the network element 130, such as packet header (e.g., source/destination address, ports, protocol) information, class/Quality of Service information, associated communication streams or conversations, application(s) associated with sending and/or receiving the traffic, and/or the contents of the traffic payloads. Based on this trust information and, optionally, additional traffic information, the storing/logging controller 115 may determine what traffic or portions of traffic associated with the network element 130 should be stored and/or logged and where the traffic should be stored and/or logged. The storing and/or logging controller 115 may incorporate or have access to rules, patterns, and/or decision data, collectively referred to herein as rules, that may be used in determining what traffic to store and/or log and at what destination(s) the traffic should be stored and/or logged.

The storing/logging API 125 may be configured to communicate with the storing/logging controller 115 to configure the appropriate devices/elements in the communication network 135 to carry out storing/logging of traffic associated with one or more network elements 130. In accordance with various embodiments of the present invention, the storing/logging API 125 may be implemented as a singular entity that carries out commands received from the storing/logging controller 115 or may be an API that allows for control of traffic storing/logging at a subscriber, premises, and/or application level.

The storing/logging API 125 may also be configured to monitor the status of a traffic storing/logging operation and provide such status information to the storing/logging controller 115. The storing/logging controller 115 may generate alarms and/or indicators based on the status of the storing/logging operation(s).

Although FIG. 1 illustrates an exemplary communication network, it will be understood that the present invention is not limited to such configurations, but is intended to encompass any configuration capable of carrying out the operations described herein.

The verification system 110, storing/logging controller 115, input monitor 120, and/or storing/logging API 125 may be embodied as one or more data processing systems that comprise, for example, input device(s), such as a keyboard or keypad, a display, and a memory that communicate with a processor. Such data processing system(s) may further include a storage system, a speaker, and an input/output (I/O) data port(s) that also communicate with the processor. The storage system may include removable and/or fixed media, such as floppy disks, ZIP drives, hard disks, or the like, as well as virtual storage, such as a RAMDISK. The I/O data port(s) may be used to transfer information between the data processing system(s) and another computer system or a network (e.g., the Internet). These components may be conventional components such as those used in many conventional computing devices, which may be configured to operate as described herein. Moreover, the functionality of the verification system 110, storing/logging controller 115, input monitor 120, and/or storing/logging API 125 may be implemented as a single processor system, a multi-processor system, or even a network of stand-alone computer systems, in accordance with various embodiments of the present invention.

Computer program code for carrying out operations of the verification system 110, storing/logging controller 115, input monitor 120, and/or storing/logging API 125 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Exemplary operations for storing/logging traffic associated with a network element based on whether the network element can be trusted, in accordance with some embodiments of the present invention, will now be described with reference to FIGS. 3, 4, and 1. Referring to FIG. 3, in accordance with some embodiments of the present invention, operations begin at block 300 where the verification system 110 determines whether a network element 130 can be trusted and/or to what degree that network element can be trusted. As discussed above and in detail in the '249 application and the '169 application, the verification system 110 may determine a degree of trust for a network element 130 by comparing hash values generated for data associated with the network element 130. Advantageously, the verification system 110 may be configured to automatically evaluate the network element 130 to determine a degree of trust for the network element 130. For example, the verification system 110 may generate a hash value for data associated with the network element 130 every time a timer expires, a packet count is reached, a particular event occurs at the network element 130, such as, for example, the start of a session initiation protocol (SIP) or Voice over Internet Protocol (VoIP) session, and/or a direct command to perform a hash operation on the data associated with the network element 130.

At block 305, the traffic associated with the network element 130 is stored and/or logged based on whether the network element 130 can be trusted. Thus, according to some embodiments of the present invention, traffic associated with a network element may be stored and/or logged based on how trusted the particular network element is. For example, if the configuration of the network element has changed (e.g., new software/firmware has been detected) in such a way that traffic associated with the network element may now be suspect (e.g., the traffic may be tampered with or may be the result of hacker activity), then the traffic or selected portions thereof may be stored and/or logged for analysis. Depending on the degree of trust determined for the network element, the traffic may be stored and/or logged for analysis by a network administrator, for example, or even law enforcement authorities if the degree of trust is very low and nature of the traffic may indicate potential criminal activity.

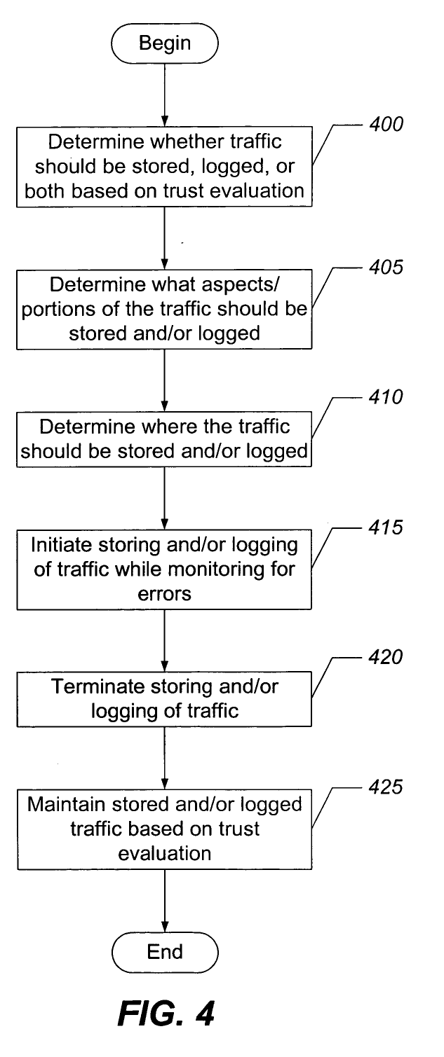

Particular embodiments for storing and/or logging traffic associated with a network element based on a whether the network element can be trusted are described hereafter with reference to FIGS. 4 and 1. Operations begin at block 400 where the storing/logging controller 115 determines whether the traffic associated with the network element 130 should be stored, logged, or both depending on whether the network element 130 can be trusted and, optionally, the degree of trust determined for the network element 130. In some embodiments, it may be desirable to store traffic associated with a network element 130 that is determined to be particularly untrustworthy while logging traffic associated with a network element 130 that is determined to be only mildly untrustworthy. Other considerations may also be included in the decision whether to store and/or log the traffic, such as storage capacity for the stored/logged traffic and/or processing resources available to manage the storing and/or logging operation(s).

At block 405, the storing/logging controller 115 may determine what aspects or portions of the traffic associated with the network element 130 should be stored and/or logged. As discussed above, the storing/logging controller 115 may select traffic associated with the network element 130 to be stored and/or logged based on rules. These rules may be based on the degree of trust determined for the network element 130. For example, the storing/logging controller 115 may use these rules to filter the traffic to be stored/logged based on packet header (e.g., source/destination address, ports, protocol), class/Quality of Service, associated communication streams or conversations, application(s) associated with sending and/or receiving traffic, and/or the contents of the traffic payloads.

The storing/logging controller 115 may also select what portions of the traffic associated with the network element 130 are to be stored/logged based on these rules. For example, the traffic headers may be stored/logged, the traffic headers and payloads may be stored/logged, a subset of the traffic headers may be stored/logged, a subset of the traffic headers and payloads may be stored/logged, and/or a periodic or random sampling of any of the foregoing may be stored/logged. Moreover, in accordance with various embodiments of the present invention, the scope of the traffic associated with the network element 130 may comprise traffic associated with a location, a connection/session, and/or an application.

In particular embodiments of the present invention, the storing/logging controller 115 may use rules for selecting traffic for storing and/or logging that include lists and/or tables for use in prioritizing the traffic according to various criteria or characteristics. Based on a particular traffic priority in conjunction, for example, with a degree of trust determined for the network element 130, the storing/logging controller may determine whether to store, log, and/or both store and log traffic associated with the network element. In accordance with various embodiments of the present invention, these lists and/or tables may be used to prioritize the traffic based on based on protocol, based on time to store and/or log the traffic, based on a source and/or destination address or range, based on an application(s) associated with sending and/or receiving the traffic, and/or based on payloads associated with the traffic.

Depending on conditions in the network 135, an administrator may wish to adjust the priorities associated with the rules used by the storing/logging controller 115 in determining whether to store and/or log traffic associated with a network element 135. For example, if it is determined that the network is under attack by hacker(s) or a virus is spreading throughout the network, then it may be desirable to adjust the rule priorities so that traffic is more likely to be stored and/or logged or it may be desirable to adjust the rule priorities so that traffic is less likely to be stored and/or logged until the virus, for example, is brought under control to avoid overwhelming the storage repositories as multiple network elements may appear to be untrustworthy due to the attack. Accordingly, in some embodiments, context information may be used to adjust the priorities used for one or more lists/tables described above, which are used in selecting traffic for storing and/or logging. In other embodiments, context information may be used to select which lists and/or tables are used to prioritize the traffic for storing and/or logging and which lists and/or tables to ignore. The context information may be supplied manually, for example, by an administrator or may be generated automatically based on conditions detected in the network 135.

Returning to FIG. 4, the storing/logging controller 115 may select a destination for storing and/or logging the traffic associated with the network element 130 based, for example, on the degree of trust associated with the network element 130 at block 410. In some embodiments, the traffic may be directed to a plurality of destinations for storing and/or logging such that different portions and/or classifications of traffic are directed to different ones of the plurality of destinations. As shown in FIG. 1, the traffic may be stored and/or logged in repositories 140a and/or 140b. These repositories may be associated with a same or different entities. As discussed above, depending on the trustworthiness of the network element 130 and/or the nature of the traffic associated with the network element 130, the traffic may be stored and/or logged at a location associated with a network administrator or even law enforcement authorities.

At block 415, the storing/logging controller 115 initiates the storing and/or logging of traffic associated with the network element 130 via the storing/logging API 125. The storing/logging API 125 may also monitor the status of the storing/logging operation(s) to determine if any errors have occurred that may justify another attempt at storing/logging the traffic associated with the network element 130 and/or provide the storing/logging controller 115 with information used to evaluate the success and/or progress of the storing/logging operation(s). Storing and/or logging of the traffic associated with a network element 130 may be stopped, for example, at block 420 when it is determined that the network element 130 can be trusted and/or upon a lapse of a defined storing and/or logging time. In some embodiments, at block 425, the traffic that is stored and/or logged in repositories 140a and/or 140b, for example, may be retained for a time period that is based on, for example, the degree of trust that is determined for the network element 130.

The flowchart of FIGS. 2-4 illustrate the architecture, functionality, and operations of some embodiments of methods, systems, and computer program products for storing/logging traffic associated with a network element based on whether the network element can be trusted. In this regard, each block represents a module, segment, or portion of code, which comprises one or more executable instructions for implementing the specified logical function(s). It should also be noted that in other implementations, the function(s) noted in the blocks may occur out of the order noted in FIGS. 2-4. For example, two blocks shown in succession may, in fact, be executed substantially concurrently or the blocks may sometimes be executed in the reverse order, depending on the functionality involved.

Some embodiments of the present invention may be illustrated by way of example. Some time in the past, the verification system 110 checks the configuration of Murray's modem such that an initial acceptable hash result is recorded. After expiration of a timer, the verification system 110 re-checks Murray's modem to record recent hash results. Murray then attempts to initiate a videoconference with a business partner in Pakistan and, for this videoconference, attempts to purchase an expensive network resource, e.g., a temporary high Quality of Service (QoS) connection, from a service provider via a separate QoS-on-demand service. The verification system 110 either re-checks Murray's modem to generate a new hash result or accesses the most recent hash result and performs a compare with the initial acceptable hash result. The verification system 110 determines that a change has occurred such that the level of trust for Murray's modem has been compromised. The verification system 110 reports a degree of trust for Murray's modem as 3 out of 10 to the storing/logging controller 115. The storing/logging controller 115 determines that for a trust value of 5 or less, storing and/logging of the traffic associated with Murray's modem is appropriate. Based on a trustworthiness value of 3 out of 10, the storing/logging controller 115 consults the appropriate prioritized list(s)/table(s) of traffic type, sources, destinations, etc. to determine that Pakistan is associated with a medium priority. Based on this priority level, the storing/logging controller determines that all traffic data should be stored as well as information pertaining to the parties logged and that this information should be retained for three months. In addition, the storing/logging controller 115 determines that the data associated with the purchase of QoS resource should be time-stamped, authenticated, and hashed together and kept as a log for six months commensurate with the service provider's business requirement to enable a legally acceptable defense against high dollar value purchase disputes, which may arise. The storing/logging controller 115 communicates with the storing/logging API 125 to initiate and terminate the storing/logging operations. The storing/logging operations are monitored for errors while in progress.

Many variations and modifications can be made to the embodiments described herein without substantially departing from the principles of the present invention. All such variations and modifications are intended to be included herein within the scope of the present invention, as set forth in the following claims.

That which is claimed:

1. A method of operating a communication network, comprising:
determining whether a network element can be trusted; and
storing and/or logging traffic associated with the network element based on whether the network element can be trusted.

2. The method of claim 1, wherein determining whether a network element can be trusted, comprises:
generating a first hash value based on data associated with the network element;
generating a second hash value based on the data associated with the network element; and
comparing the first hash value with the second hash value to determine whether the network element can be trusted.

3. The method of claim 2, wherein comparing the first hash value with the second hash value to determine whether the network element can be trusted comprises comparing the first hash value with the second hash value to determine a degree of trust for the network element.

4. The method of claim 1, wherein storing and/or logging traffic comprises:
selecting traffic for storing and/or logging using rules that are based on network element trust information.

5. The method of claim 4, wherein selecting traffic comprises:
selecting traffic for storing and/or logging based on a protocol associated with the traffic, a source and/or destination address associated with the traffic, an application associated with sending and/or receiving the traffic, and/or payloads associated with the traffic.

6. The method of claim 4, wherein the rules comprise a prioritization of the traffic based on protocol, a prioritization of the traffic based on time to store and/or log the traffic, a prioritization of the traffic based on a source and/or destination address or range, a prioritization of the traffic based on an application associated with sending and/or receiving the traffic, and/or a prioritization of the traffic based on payloads associated with the traffic.

7. The method of claim 6, further comprising:
using context information to adjust at least one prioritization of the traffic.

8. The method of claim 6, further comprising:
using context information to select at least one of the prioritizations of the traffic for use in selecting the traffic for storing and/or logging.

9. The method of claim 6, further comprising:
using degree of trust for the network element to select at least one of the prioritizations of the traffic for use in selecting the traffic for storing and/or logging.

10. The method of claim 4, further comprising:
determining whether to store or log the traffic based on degree of trust for the network element.

11. The method of claim 1, further comprising:
selecting a destination for storing and/or logging the traffic based on network element trust information.

12. The method of claim 1, further comprising:
stopping storing and/or logging of the traffic associated with the network element if it is determined that the network element can be trusted and/or upon elapse of a defined storing and/or logging time; and
retaining the stored and/or logged traffic associated with the network element for a duration that is based on degree of trust for the network element.

13. The method of claim 2, wherein generating the first hash value and generating the second hash value comprise:
generating the first hash value and the second hash value responsive to at least one of an expiration of a timer, a packet count associated with the network element, an event associated with then network element, and/or a hash generation command.

14. The method of claim 1, wherein storing and/or logging traffic comprises:
storing and/or logging traffic associated with at least one of a location, a connection/session, and/or an application.

15. A computer program product for operating a communication network, comprising:
a computer readable storage medium having computer readable program code embodied therein, the computer readable program code being configured to carry out the method of claim 1.

16. A communication network, comprising:
a verification system that is configured to determine whether a network element can be trusted; and
a storing/logging controller that is connected to the verification system and is configured to store and/or log traffic associated with the network element based on whether the network element can be trusted.

17. The communication network of claim 16, wherein the verification system is further configured to generate a first hash value based on data associated with the network element, generate a second hash value based on the data associated with the network element, and compare the first hash value with the second hash value to determine whether the network element can be trusted.

18. The communication network of claim 17, wherein the verification system is further configured to compare the first hash value with the second hash value to determine a degree of trust for the network element.

19. The communication network of claim 18, wherein the storing/logging controller is further configured to select traffic for storing and/or logging using rules that are based on the degree of trust for the network element.

20. The communication network of claim 19, wherein the rules comprise a prioritization of the traffic based on protocol, a prioritization of the traffic based on time to store and/or log the traffic, a prioritization of the traffic based on a source and/or destination address or range, a prioritization of the traffic based on an application associated with sending and/or receiving the traffic, and/or a prioritization of the traffic based on payloads associated with the traffic.
